(19) United States
(12) Patent Application Publication
(10) Pub. No.: US 2003/0042416 A1
(43) Pub. Date: Mar. 6, 2003

(54) Large geometric factor charged particle spectrometer

(76) Inventor: Luke Goembel, Baltimore, MD (US)

Correspondence Address: LUKE GOEMBEL, 1020 REGESTER AVENUE, BALTIMORE, MD, 21239, US

(21) Appl. No.: 09/940,209

(22) Filed: Aug. 28, 2001

(51) Int. Cl. H01J 49/48

(52) U.S. Cl. 250/305

(57) ABSTRACT

A spectrometer is provided for the energy analysis of charged particles. The spectrometer consists of a hemispherical capacitor energy analyzer, a collimator and entrance aperture that define the solid angle of acceptance and geometric factor of the spectrometer, and a charged particle detector. The entrance aperture and collimator are arranged to maximize the geometric factor of the analyzer while retaining high energy-resolution.

### STATEMENT REGARDING FEDERALLY SPONSORED RESEARCH OR DEVELOPMENT

This invention was not the result of federally sponsored research and development. I received no funds from the federal government during the time I invented the large geometric factor charged particle spectrometer.

### CROSS-REFERENCE TO RELATED APPLICATIONS

Not Applicable

### REFERENCE TO A MICROFICHE APPENDIX

Not Applicable

### REFERENCES

### Patents

U.S. Pat. No. 3,733,483 May 1973 Green et al. 250/49.5AE

U.S. Pat. No. 5,285,066 February 1994 Sekine et al. 250/305

U.S. Pat. No. 6,104,029 August 2000 Coxon et al. 250/305

### Other References

C. W. Carlson and J. P. McFadden, “Design and Application of Imaging Plasma Instruments”, Measurement Techniques in Space Plasmas: Particles, R. T. Pfaff, J. E. Borovsky, David T. Young, Editors, (Geophysical Monograph; 102), pp. 125-140, American Geophysical Union (Washington, D.C., 1998).

Doering, J. P., Bostrom, C. O., and Armstrong, J. C., “The Photoelectron-Spectrometer Experiment on Atmosphere Explorer,” Radio Science, Vol. 8, No. 4, pp. 387-392, 1973.

L. Goembel and J. P. Doering, “Instrument for measuring spacecraft potential”, Journal of Spacecraft and Rockets, Vol. 35, No. 1, pp. 66-72, 1998.

Goembel, L., J. P. Doering, D. Morrison, and L. J. Paxton, “Atmospheric O/N₂ ratios from photoelectron spectra”, Journal of Geophysical Research, Vol. 102, No. A4, pp. 7411-7419, 1997.

David T. Young, “Space Plasma Particle Instrumentation and the New Paradigm: Faster, Cheaper, Better”, Measurement Techniques in Space Plasmas: Particles, R. T. Pfaff, J. E. Borovsky, David T. Young, Editors, (Geophysical Monograph; 102), pp.1-16, American Geophysical Union (Washington, D.C., 1998).

U. Gelius, B. Wannberg, P. Baltzer, H. Fellner-Feldegg, G. Carlsson, G-C Johansson, J. Larsson, P. Munger, G. Vegerfors, “A New Esca Instrument with Improved Surface Sensitivity, Fast Imaging Properties and Excellent Energy Resolution”, J. of Electron Spectroscopy and Related Phenomena, Vol. 52, 1990, pp. 747-785.

### BACKGROUND OF THE INVENTION

This invention generally relates to spectroscopy and in particular relates to spectrometers and methods of spectroscopy for the energy analysis of charged particles.

Charged particle spectroscopy is a powerful tool in space science. The energy analysis of the ambient charged particles in outer space provides an understanding of geophysical and extraterrestrial phenomena. Charged particle spectroscopy in space generally involves energy analyzing the charged particles that flow from various directions toward the spacecraft. The spectra collected help us understand atmospheric phenomena such as solar photoionization of the earth's upper atmosphere and extraterrestrial phenomena such as changes in the solar wind over the solar cycle. The knowledge gained from such instruments also helps us model conditions in outer space.

Since the flow of charged particles in outer space is generally low, it is of great importance to fly instruments with a large geometric factor in order to collect data as quickly as possible. The geometric factor is proportional to the product of the charged particle energy analyzer's entrance aperture area and its solid angle of acceptance. The sensitivity of the instrument (the rate at which particles are counted for a given ambient particle flux) is proportional to the instrument's geometric factor.

In general, there is an inverse relationship between geometric factor and energy resolution for electrostatic energy analyzers. In practice, slit width is often narrowed to increase energy resolution. By narrowing slit width, geometric factor and sensitivity are reduced due to the decreased area of the entrance aperture. High energy resolution instruments tend to have a low geometric factor and high geometric factor instruments tend to have low energy resolution.

The trend in space science has been to sacrifice energy resolution in favor of geometric factor to compensate for the low particle fluxes in outer space. High geometric factor instruments can energy analyze the ambient charge particles very rapidly—but at relatively low energy resolution. Spectrometers of inherently large geometric factor and low energy resolution now dominate the field, such as those classified as quadraspherical in design. Some details of the quadraspherical (quarter of a sphere), or “top hat”, design instruments are described by C. W. Carlson et al. in Measurement Techniques in Space Plasmas: Particles, pp. 125-140, 1998.

Although the trend now is to fly compact, large geometric factor, quadraspherical charged particle analyzers, hemispherical electrostatic analyzers have flown in the past to provide very high energy-resolution spectra. Hemispherical electrostatic analyzers are preferred for high energy-resolution work because of their high charged-particle-optical efficiency and their lack of charged-particle-optical aberrations. One such instrument is described by Doering et al. in Radio Science, Vol. 8, No. 4, 1973, pp. 387-392. Although the spectrometer described by Doering et al. flew on three satellites in the 1970's, to the best of our knowledge no other instrument has flown with greater, or equal, energy-resolution. The energy resolution of the instrument was 2.5% (change in energy divided by energy, full peak width at half maximum peak height). Charge particle analyzers now used for space flight rarely have energy resolution of better than 5%, and more commonly have energy resolution in the double digits.

There is now interest in collecting high energy-resolution spectra of the charged particle in outer space. For instance, the determination of spacecraft floating potential is possible through an analysis of high energy-resolution electron energy spectra, as described in L. Goembel and J. Doering, Journal of Spacecraft and Rockets, Vol. 35, No. 1, pp. 66-72, 1998. It is important to measure spacecraft charge because even minor spacecraft charging biases scientific instruments (such as plasma spectrometers) and makes it difficult to interpret valuable data. In extreme cases rapid discharge from a spacecraft can cause costly system failures. Monitoring the charge and reducing it through a controlled discharge can prevent such damage. Other uses for high energy resolution electron spectra exist, such as in the determination of the ratio of ambient atomic oxygen to nitrogen in the upper atmosphere, as described by L. Goembel and J. P. Doering in Journal of Geophysical Research, Vol. 102, No. A4, pp. 7411-7419, 1997. There are also uses for high energy-resolution positively charged particle spectra, which will not be described here.

To date, there have been no compact, large geometric factor instruments capable of collecting high energy-resolution charged particle spectra in outer space. The high energy-resolution hemispherical analyzer-based instrument described by Doering et al. in Radio Science, Vol. 8, No. 4, pp. 387-392, 1973 would be considered bulky by today's standards. It would also be considered slow to collect spectra by today's standards since its geometric factor was small compared to the quadraspherical spectrometers that are now popular. Designers of charged particle spectrometers appear to have reached an impasse in efforts to design a compact, high geometric factor, high-energy resolution instrument. Although the fully focusing charged particle optics of the hemispherical condenser design make it the preferred configuration for high energy-resolution spectroscopy, the large hemisphere that would be needed to collect data quickly with a spectrometer of the traditional design rules out the deployment of such an instrument. The accepted rule in the design of space flight charged particle spectrometers has been “if sensor optics are focusing then little can be done to improve performance short of increasing sensor dimensions”, as quoted from D. T. Young, “Space Plasma Particle Instrumentation and the New Paradigm: Faster, Cheaper, Better”, p.8, Measurement Techniques in Space Plasmas: Particles, R. T. Pfaff, J. E. Borovsky, David T. Young, Editors, (Geophysical Monograph; 102), American Geophysical Union (Washington, D.C., 1998).

Much development of hemispherical charged particle energy analyzers has been done in fields outside of space science. The double-focusing property of the hemispherical analyzer has long been utilized in the field of surface imaging electron spectroscopy (XPS or ESCA). Hemispherical analyzers with extended arcuate slits such as shown in FIG. 6 of U.S. Pat. No. 3,733,483 to Green et al. (1973), FIG. 4a of U.S. Pat. No. 5,285,066 to Sekine et al. (1994), and FIG. 1 of U.S. Pat. No. 6,104,029 to Coxon et al. (2000) have been used to maximize the sensitivity of such instruments. In such imaging spectroscopy, focusing multi-element fore-optics are used to transmit an electron-spectroscopic image of the surface the entrance plane of the hemispherical analyzer. The resulting image on the detector has one direction representing energy, and the perpendicular direction representing position on the original surface, as described by U. Gelius et al. in J. of Electron Spectroscopy and Related Phenomena, Vol. 52, 1990, p. 761.

Traditional hemispherical charged particle analyzers for space flight have contained a circular entrance aperture, such as that of Doering et al. in Radio Science, Vol. 8, No. 4, pp. 387-392, 1973. Our invention utilizes an arcuate entrance slit to retain energy resolution while increasing aperture area, and, thus, geometric factor. Unlike imaging spectrometers that have contained arcuate slits, our invention has no imaging fore-optics but has an arcuate collimator that defines the solid angle of acceptance of the instrument. The object of our invention is to maximize the solid angle of acceptance of the instrument and maximize the aperture area of the instrument so that the ambient charged particles in space can be collected with greatest efficiency. The double focusing property of the hemispherical analyzer is used not for imaging but to maximize the solid angle of acceptance and charged-particle-optical filling of the space between the hemispherical capacitors while retaining the superb energy resolution of the hemispherical design.

The invention described here breaks through the perceived impasse in efforts to design a compact high energy-resolution, high geometric-factor charged particle analyzer. Our invention retains the energy resolution of instruments that have flown in the past, but vastly increases geometric factor, by using an arcuate slit for both the collimator and entrance aperture. It is possible to increase the geometric factor by nearly two orders of magnitude over the instrument in Doering et al. with no increase in the size. Such a dramatic increase in the geometric factor of the instrument with no increase in bulk makes the instrument competitive with similarly sized space science instruments of quadraspheric or other lower resolution design. This invention makes it possible to collect the quality data needed to determine, for instance, spacecraft floating potential with a compact instrument and with high temporal resolution.

### BRIEF SUMMARY OF THE INVENTION

It is an object of the present invention to provide a novel and simple charged particle spectrometer with a large geometric factor and high energy resolution that is capable of obtaining charged particle spectra of the environment under investigation in short time.

The above object is achieved by a charged particle spectrometer comprising: a coaxial hemispherical charged particle energy analyzer having an input slit extending in the direction perpendicular to a radial direction of the hemispherical electrodes included in the energy analyzer; an input collimator for defining the field of view of the spectrometer which is also extending in the direction perpendicular to a radial direction of the hemispherical electrodes included in the energy analyzer; and a detector placed at the output end of the hemispherical analyzer that is capable of detecting the charged particles that pass through the hemispherical analyzer.

Other objects and features of the invention will become obvious upon an understanding of the illustrative embodiment about to be described or will be indicated in the appended claims, and various advantages not referred to herein will occur to one skilled in the art upon employment of the invention in practice.

### BRIEF DESCRIPTION OF THE DRAWINGS

Examples of embodiments of the present invention will now be described with reference to the drawings, in which:

FIG. 1 is an isometric view of the assembled invention.

FIG. 2 is a sectional isometric view of the assembled invention.

FIG. 3 is an exploded view of the invention with parts labeled.

FIG. 4 is a front view of the invention with detector absent.

FIG. 5 is an enlarged detail of the area marked in FIG. 4.

FIG. 6 is a schematic drawing of the solid angle of acceptance of the spectrometer as defined by the input collimator and slit.

### REFERENCE NUMERALS IN DRAWINGS

The following reference numerals appear in the drawings:

20—Central Bolt 22—Offset Bolt

24—Radial Bolt 26—Magnetic Shield Base

28—Collimator Plate 30—Entrance Collimator

32—Exit Collimator 34—Base Plate

36—Aperture Plate 38—Entrance Aperture

40—Exit Aperture 42—Alignment Ring

44—Offset Alignment Peg 46—Central Alignment Peg

48—Inner Hemisphere 50—Outer Hemisphere

52—Spacer 54—Magnetic Shield

56—Bolt Ring 58—Charged Particle Detector

60—Spectrometer Solid Angle of Acceptance

62—Trajectory of Particle through Spectrometer

### DETAILED DESCRIPTION OF THE INVENTION

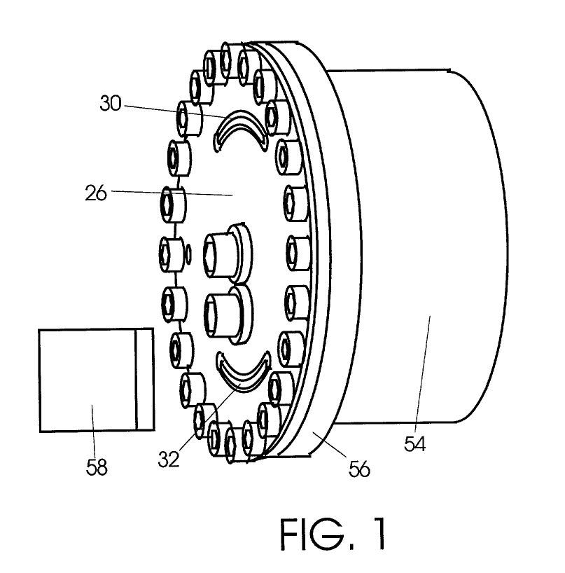

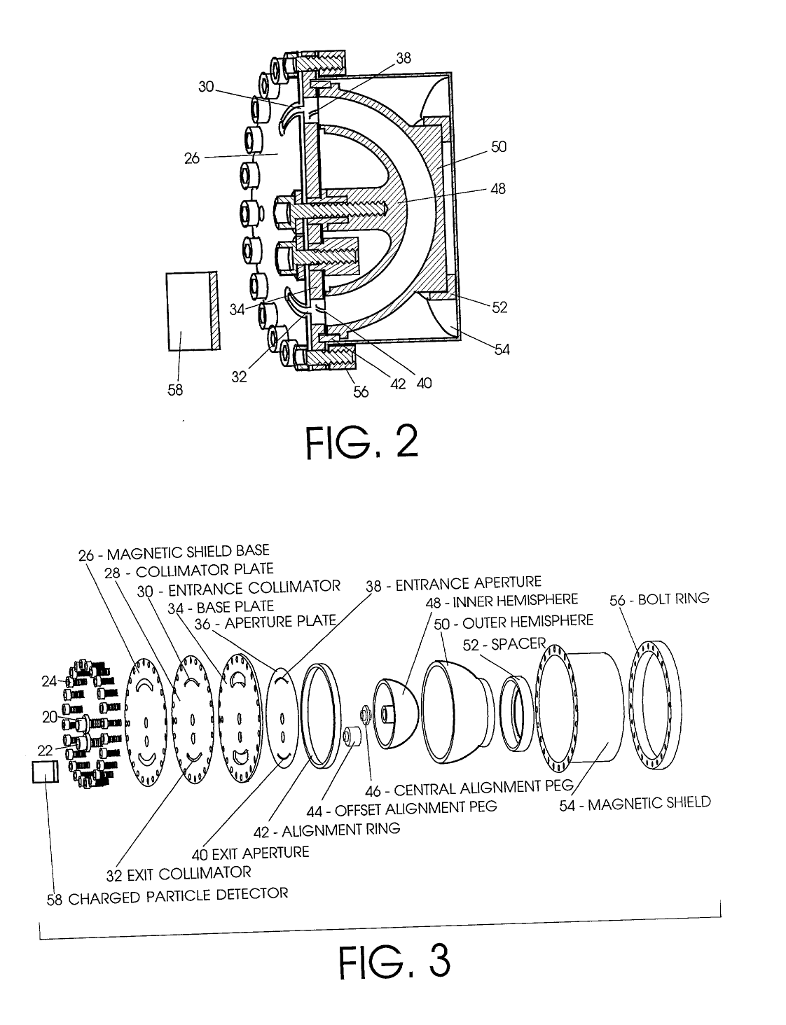

Referring to FIGS. 1, 2, and 3, in which the same reference numerals are used to designate like parts, the preferred embodiment of the invention comprises a pre-energy analysis entrance collimator 30 and an entrance aperture 38, and a hemispherical energy analyzer composed of an inner hemisphere 48 and a coaxial outer hemisphere 50. The base of hemispheres 48 and 50 define the plane of focus for the analyzer, approximately the location of an aperture plate 36. The center of aperture plate 36 therefore defines the spherical center of the charged particle analyzer. A base plate 34 separates a collimator plate 28 from aperture plate 36. Aperture plate 36 contains entrance aperture 38 and an exit aperture 40. Collimator plate 28 contains entrance collimator 30 and an exit collimator 32. A magnetic shield base 26, collimator plate 28, base plate 34, aperture plate 36, and inner hemisphere 48 are held together with a central bolt 20 and a central alignment peg 46. The collimators 30 and 32, apertures 38 and 40, openings in magnetic shield base 26, and base plate 34 are held in alignment by an offset alignment peg 44 and an offset bolt 22. Outer hemisphere 50 is aligned with inner hemisphere 48 by use of an alignment ring 42 that centers outer hemisphere 50 in a magnetic shield 54. Multiple radial bolts 24 attach a bolt ring 56, magnetic shield 54, a spacer 52, outer hemisphere 50, and alignment ring 42 to magnetic shield base 26, collimator plate 28, base plate 34, aperture plate 36, and inner hemisphere 48. A charged particle detector 58 is located at the output end of the spectrometer as shown in FIGS. 1, 2 and 6.

All of the parts of this embodiment of the inventions are constructed from conductive metal with the exception of 42, 44, 46, 52, and 58. Parts 42, 44, 46, and 52 are constructed of a non-conducting plastic to electrically isolate the conductive parts they separate. Charged particle detector 58 is constructed from a combination of conducting and non-conducting materials. Magnetically shielding parts 26 and 54 are constructed from 80% permeability mu-metal sheet. Collimator and aperture plates 28 and 36 are constructed from molybdenum sheet in this embodiment of the invention.

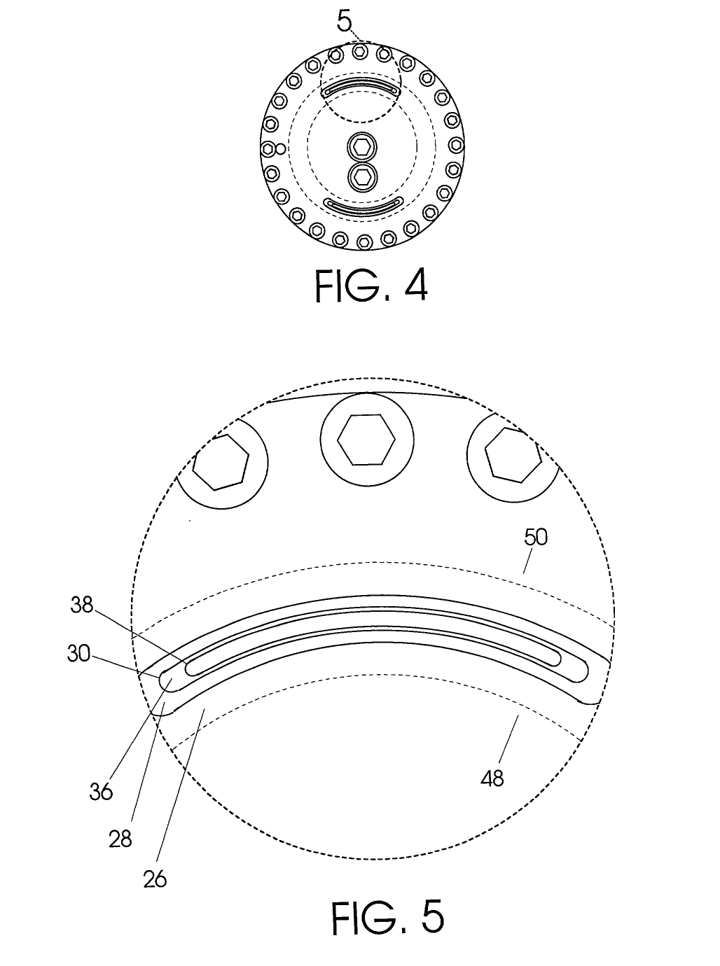

FIGS. 4 and 5 illustrate the arrangement of entrance aperture 38 and entrance collimator 30. FIG. 4 is a front view of the preferred embodiment of the invention with detector 58 absent and FIG. 5 is an enlarged view of the circular area marked in FIG. 4. A hemispherical energy analyzer comprises two concentric hemispherical electrodes 48 and 50 defining a hemispherical space between. Entrance aperture 38 is in the shape of an arcuate slit whose center of curvature coincides with the spherical center of coaxial hemispherical electrodes 48 and 50, with the slit lying on a circle whose radius is substantially midway between inner and outer hemispherical electrodes 48 and 50. Entrance aperture 38 in this embodiment of the invention extends in an arc by 60 degrees. Collimator plate 28 lies in a plane parallel to, but some distance from, aperture plate 36. In the preferred embodiment of the invention illustrated in FIGS. 1-5, collimator plate 28 is separated from aperture plate 36 by a distance that is equal to approximately 15% the radius of inner hemisphere 48. Collimator plate 28 contains entrance collimator 30, an arcuate slit whose center of curvature coincides with the spherical center of coaxial hemispherical electrodes 48 and 50, with the slit lying on a circle whose radius is substantially midway between inner and outer hemispherical electrodes 48 and 50. Entrance collimator 30 in this embodiment of the invention is an arc that extends somewhat more than 60 degrees and is somewhat wider in the radial direction than entrance aperture 38, as illustrated in FIG. 5. It is the combination of entrance collimator 30 and entrance aperture 38 that defines the solid angle of acceptance of the spectrometer.

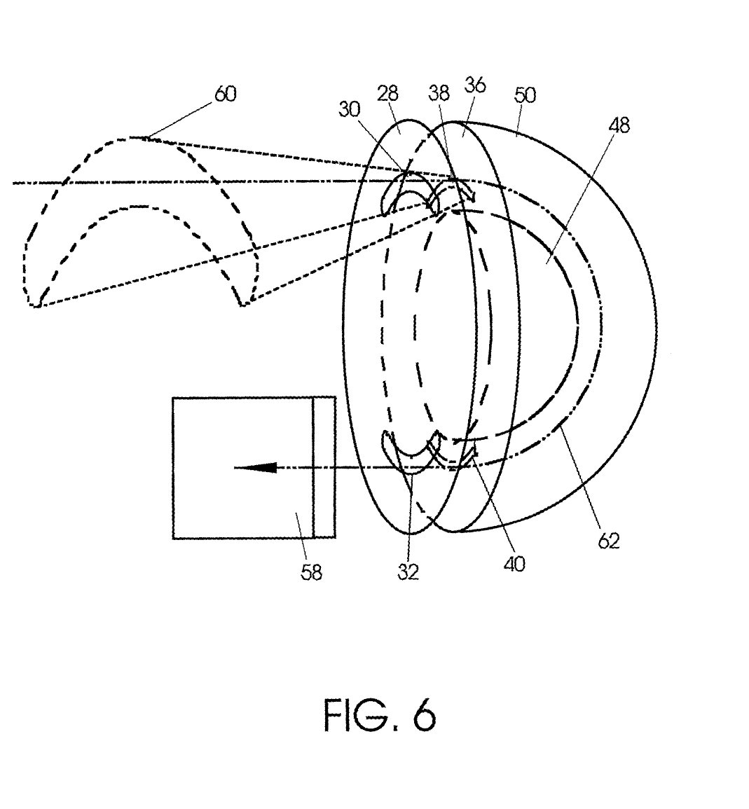

FIG. 6 is provided to illustrate the function of the preferred embodiment of the invention and is not drawn to scale. Some shapes have been simplified and some distances have been exaggerated for clarity. A voltage is applied between hemispherical electrodes 48 and 50. Aperture plate 36 and collimator plate 28 are electrically isolated from hemispherical electrodes 48 and 50. Entrance collimator 30 restricts the angle of acceptance into entrance aperture 38. The dotted outline to the left of entrance collimator 30 approximates the solid angle of acceptance 60 of this embodiment of the spectrometer. A trajectory of a charged particle through the spectrometer 62 appears as a dashed line. The electrostatic potentials of surfaces 28, 36, 48, and 50 are set to pass a particle with trajectory 62. A charged particle enters the spectrometer through entrance collimator 30 and entrance aperture 38 and follows a semicircular path with its center of radius at the hemispherical center of the instrument. The particle is then free pass through exit aperture 40 and exit collimator 32 and continue to charged particle detector 58. If a particle has more or less energy than the band-pass of the spectrometer it will not strike detector 58. If the particle does not enter the spectrometer solid angle of acceptance 60 it will not pass through the analyzer and strike detector 58. Thus charged particle detector 58 will only detect charged particles of the band of energies selected by setting the electrostatic voltages of collimator plate 28, aperture plate 36, inner hemisphere 48, and outer hemisphere 50 to electrostatic potentials known to those skilled in the art of hemispherical electrostatic charged particle energy analysis. The invention will also only detect particles that enter the spectrometer through its solid angle of acceptance 60 as defined by entrance collimator 30 and entrance aperture 38. Exit collimator 32 serves to reduce the spectrometer noise due to scattered secondary charged particles produced within the space between inner hemisphere 48 and outer hemisphere 50 in this embodiment of the invention. Exit aperture 40 serves to narrow the energies of charged particles that are allowed to reach the detector in this embodiment of the invention.

Thus, the reader will see that the invention provides for a hemispherical charged particle energy spectrometer with a larger aperture area than that with a circular entrance aperture and provides for a large solid angle of acceptance in order to have a large geometric factor. The invention will reduce the time needed to gather a charged particle energy spectrum at a given ambient flux. The invention will be especially important in the field of space science instrumentation where high-speed data collection with compact, light weight instruments is needed.

While my above description contains many specifications, these should not be construed as limitations on the scope of the invention, but rather as an exemplification of one preferred embodiment thereof. Many other variations are possible, for example in another embodiment exit collimator 32 can be eliminated and the invention will retain most of its function. Likewise, exit aperture 40 can be replaced with a position sensitive charged particle detector to retain energy resolution with the added advantage of multiple channels of energy detection at a single setting of electrostatic potentials at surfaces 28, 36, 48, and 50. The section of arc of collimators 30 and 32 and apertures 38 and 40 could be less, or more, than the 60% in the preferred embodiment of the invention and the advantages of this invention would be retained. Other shapes described for the preferred embodiment of the invention can be changed slightly and the advantages of the invention will be retained. For example, inner hemisphere 48 and outer hemisphere 50 could be very nearly hemispherical rather than exactly hemispherical, or arcuate entrance collimator 30 could have a shape that very nearly, rather than exactly, follows an arc and the advantages of this invention would be retained.

Accordingly, the scope of the invention should be determined not by the embodiments illustrated, but by the appended claims and their legal equivalents.

Having thus described my invention with the detail and particularity required by the patent laws, what is claimed to be protected by Letters Patent is set forth in the following claims:

1. A charged particle spectrometer comprising:
a. a hemispherical energy analyzer consisting of coaxial substantially hemispherical electrodes for analyzing energies of charged particles;
b. a curved entrance collimator arranged to admit charged particles with said entrance collimator a substantially arcuate slit whose center of curvature coincides substantially with the spherical center of said coaxial hemispherical electrodes, with said slit lying substantially on a circle whose radius is substantially midway between said coaxial hemispherical electrodes;
c. a curved entrance aperture arranged to admit the charged particles with said entrance aperture a substantially arcuate slit whose center of curvature coincides substantially with the spherical center of said coaxial hemispherical electrodes, with the said slit lying substantially on a circle whose radius is substantially midway between said coaxial hemispherical electrodes; and
d. a detector for detecting said charged particles,
wherein said analyzer, collimator, entrance aperture, and detector are arranged to provide a large solid angle of acceptance.

2. A charged particle spectrometer as claimed in claim 1, wherein there is an exit aperture with said exit aperture a substantially arcuate slit whose center of curvature coincides substantially with the spherical center of said coaxial hemispherical electrodes, with the said slit lying substantially on a circle whose radius is substantially midway between said coaxial hemispherical electrodes.

3. A charged particle spectrometer as claimed in claim 1, wherein there is an exit collimator with said exit collimator a substantially arcuate slit whose center of curvature coincides substantially with the spherical center of said coaxial hemispherical electrodes, with the said slit lying substantially on a circle whose radius is substantially midway between said coaxial hemispherical electrodes.

4. A charged particle spectrometer as claimed in claim 1, wherein there is a position sensitive multi-channel charged particle detector to provide for the detection of particles at various energies simultaneously.
